(19) United States
(12) Patent Application Publication
(10) Pub. No.: US 2026/0233908 A1
(43) Pub. Date: Aug. 13, 2026

(54) PACKAGE MATERIAL AND METHOD OF PRODUCING A PACKAGE MATERIAL

(71) Applicant: SONY GROUP CORPORATION, TOKYO (JP)

(72) Inventors: YUUKO TABEI, TOKYO (JP); SEIJI YAMADA, TOKYO (JP); YASUTOSHI KAWATE, TOKYO (JP); NAOTO MORINAGA, TOKYO (JP); TAKAYUKI YAGI, TOKYO (JP); SATOSHI AWATSUJI, TOKYO (JP); MITSUHIRO OKAMOTO, TOKYO (JP); JUNKO KATSURAKU, TOKYO (JP); KAZUHIKO AIKO, TOKYO (JP); YASUNORI KONISHI, TOKYO (JP); TOMONORI WATANABE, TOKYO (JP); JUN NISHIMURA, TOKYO (JP)

(21) Appl. No.: 19/119,132

(22) PCT Filed: Oct. 6, 2023
(86) PCT No.: PCT/JP2023/036493

§ 371 Date: May 5, 2026

(30) Foreign Application Priority Data
Oct. 14, 2022 (JP) 2022-165671

(51) Int. Cl. B65D 65/38; B27N 5/00

(52) U.S. Cl. CPC B65D 65/38; B27N 5/00; B65D 2565/384

(57) ABSTRACT

To provide a technology capable of producing a package material that contributes highly to an environment. Provided is a package material, including: a fibrous material that includes waste paper and/or pulp; a binder; sodium hydrogen carbonate; a surfactant; and a water-soluble softener, the binder including one or more selected from polysaccharides and proteins. A urea derivative having a chemical structural formula of R¹, R²—N—CO—N—R³, R⁴ (R¹ to R⁴: H or a saturated and/or unsaturated hydrocarbon group having 1 to 4 carbon atoms) can be used as the softener according to the present technology. Further, a water-soluble polyhydric alcohol having 3 to 15 carbon atoms can also be used as the softener used in the package material according to the present technology. In this case, a polyhydric alcohol in which the number of carbon atoms and the number of hydroxy (OH) groups in a molecular structure satisfy the following relationship: the number of hydroxy groups<the number of carbon atoms can be used as the polyhydric alcohol.

### TECHNICAL FIELD

The present technology relates to a package material and a method of producing a package material.

### BACKGROUND ART

Many cushioning materials used for transporting office automation (OA) equipment, home appliances, and the like use a synthetic resin material as a raw material. Examples thereof include synthetic resin products such as polystyrene foam, a highly-foamed polyethylene sheet, foamed polyethylene, and an air cap.

Meanwhile, there is a worldwide demand for a cushioning material using an environmentally friendly and recyclable material as a raw material. Examples of the recyclable cushioning material include a cushioning material using paper. The cushioning material using paper as a raw material has a problem that the physical properties such as durability, elasticity, and resilience are inferior to those of a cushioning material using a synthetic resin material as a raw material.

Under such a background, in recent years, a technology for improving the physical properties of a cushioning material using recyclable paper as a raw material has been developed. For example, Patent Literature 1 discloses a light and elastic cushioning material characterized by including a foam molding product in which a paper component and a binder containing 50 weight % or more of gelatin or alginic acid are mixed.

Further, Patent Literature 2 discloses a foam molding product with less occurrence of avatar-like recesses on the surface and excellent elastic performance, which is obtained by kneading a fibrous material and an aqueous solution in which a binder mainly containing gelatin and/or glue with a jelly strength of 130 bloom or more is dissolved and performing foam-molding.

### CITATION LIST

### Patent Literature

Patent Literature 1: Japanese Patent Application Laid-open No. 10-152173

Patent Literature 2: Japanese Patent Application Laid-open No. 2002-293980

### DISCLOSURE OF INVENTION

### Technical Problem

As described above, a package material having excellent elasticity, which uses paper or the like as a raw material, has been developed as a technology for improving the physical properties of a cushioning material using recyclable paper or the like as a raw material, but further consideration for the environment is desired.

In this regard, a main object of the present technology is to provide a technology capable of producing a package material that contributes highly to an environment.

### Solution to Problem

That is, the present technology provides, first, a package material, including:
a fibrous material that includes waste paper and/or pulp;
a binder;
sodium hydrogen carbonate;
a surfactant; and
a water-soluble softener,
the binder including one or more selected from polysaccharides and proteins.

A urea derivative having a chemical structural formula of R¹, R²—N—CO—N—R³, R⁴ (R¹ to R⁴: H or a saturated and/or unsaturated hydrocarbon group having 1 to 4 carbon atoms) can be used as the softener according to the present technology.

Further, a water-soluble polyhydric alcohol having 3 to 15 carbon atoms can also be used as the softener used in the package material according to the present technology. In this case, a polyhydric alcohol in which the number of carbon atoms and the number of hydroxy (OH) groups in a molecular structure satisfy the following relationship: the number of hydroxy groups<the number of carbon atoms can be used as the polyhydric alcohol.

The package material according to the present technology may further include a discoloration inhibitor. As the discoloration inhibitor, a discoloration inhibitor that includes alum can be used.

Further, the package material according to the present technology may further include an antibacterial agent. As the antibacterial agent, an antibacterial agent that includes potassium sorbate can be used.

As the surfactant used in the package material according to the present technology, a surfactant that includes polyoxyethylene alkylether can be used.

The package material according to the present technology may have an embossed sheet shape.

Further, the package material according to the present technology may further include a base layer having a thickness of 1 mm or more, the base layer having a sheet shape having a first surface and a second surface.

At this time, the package material according to the present technology may further include a structure layer in which a plurality of structures is formed on the first surface and/or the second surface of the base layer.

The structure layer may be configured to have a thickness larger than a thickness of the base layer.

The plurality of structures may be formed with intervals therebetween.

The package material may be bonded to the base material via an adhesive layer.

The present technology further provides a method of producing a package material, including: a binder mixing step of mixing a binder including one or more selected from polysaccharides and proteins with an aqueous solution including a surfactant;
a mixing step of mixing a composition that includes an aqueous solution including the surfactant and the binder, a fibrous material that includes waste paper and/or pulp, sodium hydrogen carbonate, and a softener that is a urea derivative having a chemical structural formula of R¹, R²—N—CO—N—R³, R⁴ (R¹ to R⁴: H or a saturated and/or unsaturated hydrocarbon group having 1 to 4 carbon atoms); and
a foaming step of foaming the composition.

The method of producing a package material according to the present technology may further include a molding step of molding the composition using a mold and/or an embossed sheet.

Further, the method of producing a package material according to the present technology may further include a drying step of drying the foamed composition.

As the mold and/or the embossed sheet used in the molding step, a mold and/or an embossed sheet that includes silicon can be used.

### BRIEF DESCRIPTION OF DRAWINGS

FIG. 1 is a flowchart of a first embodiment of a method of producing a foam material 1 used in the present technology.

FIG. 2 is a photograph substituted for a drawing showing an example of an embodiment of the foam material 1 used in the present technology.

FIG. 3 is a cross-sectional view of the foam material 1 shown in FIG. 2.

FIG. 4 is a schematic diagram showing an example of an embodiment of the foam material 1 used in the present technology.

FIG. 5 is a schematic diagram showing an example of the embodiment of the foam material 1 used in the present technology, which is different from that shown in FIG. 4.

FIG. 6 is a photograph substituted for a drawing showing an example of the embodiment of the foam material 1 used in the present technology, which is different from those shown in FIG. 4 and FIG. 5.

FIG. 7 is a photograph substituted for a drawing showing an example of the embodiment of the foam material 1 used in the present technology, which is different from those shown in FIG. 4 to FIG. 6.

FIG. 8 is a photograph substituted for a drawing showing an example of the embodiment of the foam material 1 used in the present technology, which is different from those shown in FIG. 4 to FIG. 7.

FIG. 9 is a schematic diagram showing an example of a method of producing the foam material 1 used in the present technology.

FIG. 10 is a schematic diagram showing an example of the method of producing the foam material 1 used in the present technology, which is different from that shown in FIG. 9.

FIG. 11 is a schematic diagram showing an example of the method of producing the foam material 1 used in the present technology, which is different from those shown in FIG. 9 and FIG. 10.

FIG. 12 is a flowchart of a second embodiment of the method of producing the foam material 1 used in the present technology.

FIG. 13 is a photograph substituted for a drawing showing an example of a composite material 2 used in the present technology.

FIG. 14 is a photograph substituted for a drawing showing an example of the composite material 2 used in the present technology, which is different from that shown in FIG. 13.

FIG. 15 is a flowchart of a first embodiment of a method of producing the composite material 2 used in the present technology.

FIG. 16 is a schematic diagram showing an example of the method of producing the composite material 2 used in the present technology.

FIG. 17 is a schematic diagram showing an example of the method of producing the composite material 2 used in the present technology, which is different from that shown in FIG. 16.

FIG. 18 is a schematic diagram showing a first embodiment of a multilayer structure 3 used in the present technology.

FIG. 19 is a schematic diagram showing a second embodiment of the multilayer structure 3 used in the present technology.

FIG. 20 is a schematic diagram showing a third embodiment of the multilayer structure 3 used in the present technology.

FIG. 21 is a schematic diagram showing a fourth embodiment of the multilayer structure 3 used in the present technology.

FIG. 22 is a schematic diagram showing a fifth embodiment of the multilayer structure 3 used in the present technology.

FIG. 23 is a schematic diagram showing a sixth embodiment of the multilayer structure 3 used in the present technology.

FIG. 24 is a flowchart of a first embodiment of a method of producing the multilayer structure 3 used in the present technology.

### MODE(S) FOR CARRYING OUT THE INVENTION

Suitable embodiments for carrying out the present technology will be described below with reference to the drawings.

The embodiments described below merely show an example of a typical embodiment of the present technology and do not mean that the scope of the present technology will be interpreted narrowly. Note that the description will be made in the following order.

1. Foam material 1
(1) Fibrous material
(2) Binder
(3) Foam promotor
(4) Surfactant
(5) Water-soluble softener
(6) Discoloration inhibitor
(7) Antibacterial agent
(8) Other components
(9) Specific gravity
(10) Uses of foam material 1

2. Method of producing foam material 1

[First embodiment]
(1) Defibration step S1
(2) Binder mixing step S2
(3) Mixing step S3
(4) Foaming step S4
(5) Molding step S5
(6) Drying step S6

[Second embodiment]
(7) Application step S7
(8) Stacking step S8
(9) Drying step S9

3. Composite material 2
(1) Base material (member) 21
(2) Uses of composite material 2

4. Method of producing composite material 2
(1) Attachment step S10
(2) Drying step S11

5. Multilayer structure 3
(1) Adhesive layer 32
(2) Embodiment of multilayer structure 3
(3) Uses of multilayer structure 3

6. Method of producing stacked structure 3
(1) Application step S12
(2) Stacking step S13
(3) Drying step S14
(4) Molding step S15

As a package material according to the present technology, a foam material 1 described below can be used. The foam material 1 used as the package material according to the present technology will be described below.

### 1. Foam Material 1

The foam material 1 used in the present technology includes: a fibrous material; a binder; a foam promotor; a surfactant; and a water-soluble softener. Further, it may further include other components such as a discoloration inhibitor and an antibacterial agent as necessary. Each component will be described below in detail.

### (1) Fibrous Material

As a fibrous material used in the foam material 1 used in the present technology, one or two or more types of fibrous materials that can be used in the foam material can be freely selected and used as long as the effects of the present technology are not impaired. Examples thereof include waste paper such as newspaper, a magazine, a book, and cardboard, cotton fabric, wool fabric, pulp (bamboo, bagasse, straw, and the like), glass fiber, and chemical fiber. Among these, in the present technology, it is favorable to use waste paper such as newspaper, a magazine, a book, and cardboard from the viewpoint of recyclability.

More specifically, as the foam material 1 used in the present technology, it is favorable to use a fibrous material that includes waste paper and/or pulp. By using a fibrous material that includes waste paper and/or pulp, it is possible to improve the recyclability. Examples of the waste paper include newspaper, a magazine, a book, and cardboard as described above. Examples of the pulp include wood and non-wood. Examples of the non-wood include bamboo, bagasse, and straw.

The length of the fibrous material used in the present technology can be freely set as long as the effects of the present technology are not impaired. For example, a fibrous material defibrated to a length of 0.3 to 1.2 mm, favorably 0.3 to 1.0 mm, more favorably 0.5 to 1.0 mm, can be used.

### (2) Binder

As the binder used in the foam material 1 used in the present technology, one or two or more types of binders that can be used in a foam material can be freely selected and used as long as the effects of the present technology are not impaired. Examples thereof include polyvinylalcohol, polyethylene glycol, polyethylene succinate, polybutylene succinate, polybutylene succinate⋅adipate, polycaprolactone, polylactic acid, gum arabic, polysaccharides (e.g., carboxymethyl cellulose, hydroxypropyl cellulose, hydroxyethyl cellulose, methyl cellulose, cellulose acetate, starch, carrageenan, xanthan gum, agar, guar gum, tara gum, locust bean gum, glucomannan, gum arabic, gellan gum, alginic acid, pectin, etc.), and proteins (e.g., casein, gelatin, glue, egg white, etc.). Among these, from the viewpoint of high contribution to the environment, it is favorable to select one or two or more types of polysaccharides and proteins.

The viscosity of the binder aqueous solution used in the foam material 1 used in the present technology is not particularly limited as long as the effects of the present technology are not impaired. However, for example, it is favorable to use a binder aqueous solution having static viscosity of 50 mPa/s or more at room temperature (25° C.), and it is more favorable to use a binder aqueous solution having static viscosity of 220 mPa/s or more at room temperature. By using the binder aqueous solution having the lower limit value of static viscosity within this range, it is possible to improve the foaming property in a mixing step S3 of materials in a method of producing the foam material 1 described below.

Further, for example, it is favorable to use a binder aqueous solution having static viscosity of 450 mPa/s or less at room temperature, and it is more favorable to use a binder aqueous solution having static viscosity of 240 mPa/s or less at room temperature. By using the binder aqueous solution having the upper limit value of static viscosity within this range, it is possible to improve the workability in a foaming step S4 of materials in a method of producing the foam material 1 described below.

Note that in the present technology, the static viscosity is a value measured using a vibration type viscometer Visco Mate VM-100A (manufactured by SEKONIC CORPORATION).

The structure of the binder used in the foam material 1 used in the present technology is not particularly limited as long as the effects of the present technology are not impaired. However, it is favorable that the ratio of functional groups having low polarity to the total number of functional groups is low. By using a binder with a low ratio of functional groups having low polarity, it is possible to improve the foaming property in the foaming step S4 of materials in the method of producing the foam material 1 described below. Specifically, it is favorable to use a binder with the ratio of functional groups having high polarity of 6.7 to 23.3%.

More specifically, for example, in the case where carboxymethyl cellulose, which is one of polysaccharides, is used as a binder, carboxymethyl cellulose has a hydroxy group (—OH) and a carboxymethyl group (—CH₂COO—), and the polarity of these functional groups satisfy the following relationship: the hydroxy group (—OH)<the carboxymethyl group (—CH₂COO—). For this reason, in the present technology, in the case where carboxymethyl cellulose is used as a binder, it is favorable to use carboxymethyl cellulose with a low ratio of carboxymethyl groups (—CH₂COO—), i.e., a low degree of etherification (DS value). As a specific numerical value, it is favorable to use carboxymethyl cellulose with the degree of etherification (DS value) of 0.2 to 0.7 in the case where carboxymethyl cellulose is used as a binder in the present technology.

Further, for example, in the case where hydroxypropyl cellulose or hydroxyethyl cellulose, which is one of polysaccharides, is used as a binder, hydroxypropyl cellulose or hydroxyethyl cellulose has a hydroxy group (—OH), a hydroxypropyl group (—CH₂C(OH)HCH₃), and a hydroxyethyl group (—CH₂CH₂OH), and the polarity of these functional groups satisfy the following relationships: the hydroxy group (—OH)>the hydroxypropyl group (—CH₂C(OH)HCH₃) and the hydroxy group (—OH)>the hydroxyethyl group (—CH₂CH₂OH). For this reason, it is favorable to use hydroxypropyl cellulose or hydroxyethyl cellulose with a low ratio of hydroxy groups (—OH) in the case where hydroxypropyl cellulose or hydroxyethyl cellulose is used as a binder in the present technology. As a specific numerical value, it is favorable to use carboxymethyl cellulose or hydroxyethyl cellulose with the ratio of hydroxy groups (—OH) of 6.7 to 23.3% in the case where hydroxypropyl cellulose or hydroxyethyl cellulose is used as a binder in the present technology.

The content of the binder in the foam material 1 used in the present technology is not particularly limited as long as the effects of the present technology are not impaired, but is favorably 3 to 100 parts by mass, more favorably 7 to 70 parts by mass, with respect to 100 parts by mass of the fibrous material.

The concentration of the binder aqueous solution used in the foam material 1 used in the present technology is not particularly limited as long as the effects of the present technology are not impaired. However, for example, it is favorable to use 1 mass % or more of the binder aqueous solution, and it is more favorable to use 2 mass % or more of the binder aqueous solution. By using the binder aqueous solution having the lower limit value of the concentration within this range, it is possible to improve the strength of the foam material 1 produced.

Further, for example, it is favorable to use 11 mass % or less of the binder aqueous solution, it is more favorable to use 7 mass % or less of the binder aqueous solution, and it is still more favorable to use 5 mass % or less of the binder aqueous solution. By using the binder aqueous solution having the upper limit value of the concentration within this range, it is possible to improve the foaming property in the foaming step S4 of materials in the method of producing the foam material 1 described below and reduce the specific gravity of the foam material 1 produced.

### (3) Foam Promotor

As the foam promotor used in the foam material 1 used in the present technology, one or two or more types of foam promotors that can be used in the foam material can be freely selected and used as long as the effects of the present technology are not impaired. Examples thereof include an azo compound such as azodicarbonamide (ADCA), a nitroso compound such as N,N′-dinitrosopentamethylenetetramine (DPT), 4,4-oxybis(benzenesulfonylhydrazide) (OBSH), a hydrazine derivative such as hydrazodicarbonamide (HDCA), an azo compound such as barium azodicarboxylate (Ba/AC), and a bicarbonate such as sodium hydrogen carbonate (baking soda). Among these, it is favorable to use sodium hydrogen carbonate (baking soda) from the viewpoint of availability and economy.

In the present technology, by using sodium hydrogen carbonate (baking soda) as a foam promotor, it is possible to reduce the specific gravity of the foam material using a fibrous material that includes waste paper and/or pulp, and thus improve cushioning properties and the like.

The content of the foam promotor in the foam material 1 used in the present technology is not particularly limited as long as the effects of the present technology are not impaired, but is favorably 0.5 to 15 parts by mass, more favorably 1 to 10 parts by mass, with respect to 100 parts by mass of the fibrous material.

### (4) A Surfactant

As the surfactant used in the foam material 1 used in the present technology, one or two or more types of surfactants that can be used in the foam material can be freely selected and used as long as the effects of the present technology are not impaired. Examples thereof include polyoxyethylene alkylether, sodium alkylsulfate, alkyltrimethylammonium chloride, and alkyldiaminoethylglycine chloride. Among these, it is favorable to use polyoxyethylene alkylether from the viewpoint of promoting foaming.

The content of the surfactant in the foam material 1 used in the present technology is not particularly limited as long as the effects of the present technology are not impaired, but is favorably 0.1 to 50 parts by mass, more favorably 10 to 30 parts by mass, with respect to 100 parts by mass of the fibrous material.

The concentration of the surfactant aqueous solution used in the foam material 1 used in the present technology is not particularly limited as long as the effects of the present technology are not impaired. However, for example, in the binder mixing step in the method of producing the foam material 1 described below, the concentration of the surfactant in the binder+surfactant aqueous solution is adjusted to favorably 1 mass % or more, more favorably 3 mass % or more, and still more favorably 4 mass % or more. By adjusting the lower limit value of the concentration of the surfactant to this range, it is possible to improve the foaming property in the foaming step S4 of materials in the method of producing the foam material 1 described below and reduce the specific gravity of the foam material 1 produced.

Further, for example, in the binder mixing step in the method of producing the foam material 1 described below, the concentration of the surfactant in the binder+surfactant aqueous solution is favorably adjusted to 20 mass % or less, more favorably 15 mass % or less, and still more favorably 10 mass % or less. By adjusting the upper limit value of the concentration of the surfactant to this range, it is possible to improve the foaming property in the mixing step S3 of materials in the method of producing the foam material 1 described below.

### (5) Water-Soluble Softener

The foam material 1 used in the present technology is characterized by using a water-soluble softener. In the present technology, it has been found that the occurrence of “migration” from the produced foam material 1 to a contact object can be controlled in accordance with the type of water-soluble softener. That is, it has been found that the occurrence of “migration” from the produced foam material 1 to a contact object can be reduced by changing the type of water-soluble softener.

As the water-soluble softener that can be used in the foam material 1 according to the present technology, one or two or more types of water-soluble softeners that can be used in the foam material can be freely selected and used as long as the effects of the present technology are not impaired. Examples thereof include: urea, a urea derivative; polyhydric alcohols such as glycerin, ethylene glycol, diethylene glycol, polyethylene glycol, polyvinylalcohol, propylene glycol, and butylene glycol; a saccharide such as sucrose and trehalose; sugar alcohols such as sorbitol; and amines such as triethanolamine.

By changing the types and combinations of these water-soluble softeners, it is possible to control the occurrence of “migration” from the produced foam material 1 to a contact object.

In the case where the purpose is to reduce “migration”, it is favorable to use a softener having a weak hydrogen bonding force due to its structure. Using a softener having a structure with a weak hydrogen bonding force prevents “migration” due to the hydrogen bond from occurring. For example, since the hydrogen bonding force satisfies the relationship of O—H>N—H, the occurrence of “migration” from the produced foam material 1 to a contact object can be reduced more by using a softener having an imino group (NH group) than a softener having a hydroxy group (OH group).

Further, in the case of a chemical substance having a hydroxyl (OH) group, the lower the ratio of the number of hydroxy (OH) groups to the number of carbon atoms, the lower the hydrogen bonding force, and the more the occurrence of “migration” from the produced foam material 1 to a contact object can be reduced. Therefore, in the case of using polyhydric alcohols, it is favorable to use a polyhydric alcohol in which the number of carbon atoms and the number of hydroxy (OH) groups in a molecular structure satisfy the following relationship: the number of hydroxy groups<the number of carbon atoms.

Considering the above, specifically, among the above softeners, it is favorable to use urea, a urea derivative; propylene glycol, 1,3-butylene glycol among polyhydric alcohols having 3 to 15 carbon atoms; and sucrose, and trehalose.

In the case of using urea or a urea derivative, it is more favorable to use a urea derivative having a chemical structural formula of R¹, R²—N—CO—N—R³, R⁴ (R¹ to R⁴: H or a saturated and/or unsaturated hydrocarbon group having 1 to 4 carbon atoms). This is because the urea derivative in which the number of carbon atoms in the saturated and/or unsaturated hydrocarbon group is four or less definitely exhibits water solubility.

The content of the water-soluble softener in the foam material 1 according to the present technology is not particularly limited as long as the effects of the present technology are not impaired, but is favorably 0.03 to 150 parts by mass, more favorably 0.05 to 100 parts by mass, with respect to 100 parts by mass of the fibrous material.

Incidentally, a foam material using a fibrous material that includes waste paper and/or pulp requires a softener for imparting elasticity, and glycerin has been generally used as the softener. However, when a foam material using glycerin is used as a cushioning material for parts using a resin, metal, or the like over a long period of time, a “migration” phenomenon in which the parts become discolored occurs in some cases. A technology for improving the “migration” phenomenon from the foam material is being developed. However, since the softener significantly affects the cushioning power of the foam material, it has been difficult to apply an existing technology for improving the “migration” phenomenon to the foam material using a fibrous material that includes waste paper and/or pulp. Under such a background, the present inventors have successfully suppressed the “migration” phenomenon while maintaining favorable cushioning properties even with the foam material using a fibrous material that includes waste paper and/or pulp, by using a specific softener.

From such a viewpoint, it is favorable to use, as a softener used in the foam material 1 used in the present technology, a urea derivative having a chemical structural formula of R¹, R²—N—CO—N—R³, R⁴ (R¹ to R⁴: H or a saturated and/or unsaturated hydrocarbon group having 1 to 4 carbon atoms) and/or a water-soluble polyhydric alcohol having 3 to 15 carbon atoms, in which the number of carbon atoms and the number of hydroxy (OH) groups in a molecular structure satisfy the following relationship: the number of hydroxy groups<the number of carbon atoms (propylene glycol, butylene glycol, etc.). The urea derivative in which the number of carbon atoms of the saturated and/or unsaturated hydrocarbon group is four or less definitely exhibits water solubility. In the case of chemical substances having a hydroxy group (OH group), the lower the ratio of the number of hydroxy (OH) groups to the number of carbon atoms, the lower the hydrogen bonding force becomes, and the more the occurrence of “migration” from the produced foam material 1 to a contact object can be reduced.

### (6) Discoloration Inhibitor

A discoloration inhibitor can be used in the foam material 1 used in the present technology. As the discoloration inhibitor used in the foam material 1 used in the present technology, one or two or more types of discoloration inhibitors that can be used in the foam material can be freely selected and used as long as the effects of the present technology are not impaired. Examples thereof include alum, magnesium, iron, and copper. Among these, it is favorable to use alum from the viewpoint of availability, ease of handling, and economy.

The content of the discoloration inhibitor in the foam material 1 used in the present technology is not particularly limited as long as the effects of the present technology are not impaired, but is favorably 0.5 to 5 parts by mass, more favorably 1 to 3 parts by mass, with respect to 100 parts by mass of the fibrous material.

### (7) Antibacterial Agent

An antibacterial agent can be used in the foam material 1 used in the present technology. As the antibacterial agent used in the foam material 1 used in the present technology, one or two or more types of antibacterial agents that can be used in the foam material can be freely selected and used as long as the effects of the present technology are not impaired. Examples thereof include potassium sorbate, isopropylmethylphenol, and salicylic acid. Among these, it is favorable to use potassium sorbate from the viewpoint of handling such as water solubility.

The content of the antibacterial agent in the foam material 1 used in the present technology is not particularly limited as long as the effects of the present technology are not impaired, but is favorably 0.1 to 1.5 parts by mass, more favorably 0.15 to 1 parts by mass, with respect to 100 parts by mass of the fibrous material.

### (8) Other Components

One or two or more types of other additives that can be used in the foam material can be freely selected and used in the foam material 1 used in the present technology as necessary. Examples thereof include a crosslinking accelerator, a release agent, a pH adjuster, a pH buffer, an antifungal agent, a coloring agent, a bleach, an antioxidant, a weathering (light-resistance) agent, a flame retardant, and a filler.

### (9) Specific Gravity

The specific gravity of the foam material 1 used in the present technology can be freely set in accordance with the application and purpose. The specific gravity of the foam material 1 used in the present technology is, for example, 0.3 to 0.5, favorably 0.3 to 0.4. Further, the specific gravity of the foamed mixture after the mixing step S3 of materials in the method of producing the foam material 1 described below is, for example, 0.3 to 0.5, favorably 0.3 to 0.4. Further, the specific gravity of the binder+surfactant aqueous solution after the binder mixing step S2 in the method of producing the foam material 1 described below is, for example, 0.2 to 0.7, favorably 0.2 to 0.35. By setting the specific gravity of each of the foam material 1, the foamed mixture in the production step, and the binder+surfactant aqueous solution within this range, it is possible to further improve the impact resistance, resilience after impact, and the like.

Note that in the present technology, the specific gravity is a value measured in accordance with JIS Z8804.

### (10) Uses of Foam Material 1

The uses of the foam material 1 used in the present technology described above are not particularly limited. However, the foam material 1 can be suitably used for applications such as a cushioning material, a package material, a sound absorbing material, a sound insulation material, a soundproofing material, a vibration isolating material, an insulation material, wallpaper, a seat for automobiles, a curing material, and an agricultural material.

Further, by using a recyclable material as the above-mentioned fibrous material, it can be expected to be used as a recycled material.

### 2. Method of Producing Foam Material 1

The method of producing the foam material 1 according to the present technology is not particularly limited because the foam material 1 has a novel composition. However, the foam material 1 can be produced by the production method according to the present technology described below as a suitable method. The method of producing the foam material 1 used in the present technology may include at least a binder mixing step S2, a mixing step S3, and a foaming step S4. Further, it may further include, as necessary, a defibration step S1, a molding step S5, a drying step S6, an application step S7, a stacking step S8, a drying step S9, and the like. Details of each step will be described below in chronological order.

### FIRST EMBODIMENT

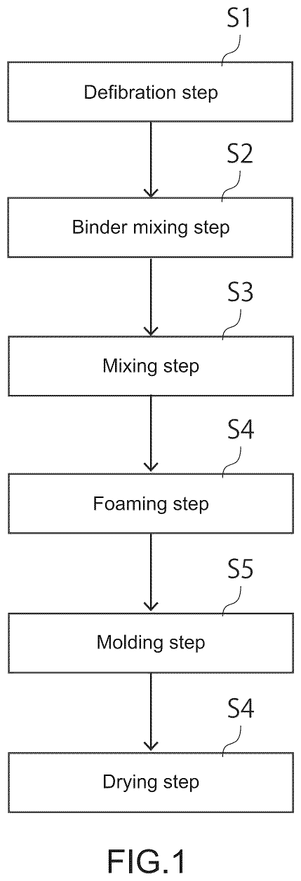

FIG. 1 is a flowchart of a first embodiment of the method of producing the foam material 1 used in the present technology.

### (1) Defibration Step S1

The defibration step S1 is a step of defibrating a fibrous material that is a raw material of the foam material 1 used in the present technology. Note that in the case of using a fibrous material that has been defibrated, this defibration step S1 is not essential.

In the present technology, as the defibration method, one or two or more types of general defibration methods can be used in combination as long as the effects of the present technology are not impaired. For example, both a wet defibration method and a dry defibration method can be used. As a specific method of defibration, cutting, crushing, smashing, impact crushing, crushing with ultrasonic waves, and the like can be freely combined and used in accordance with the type of raw material.

### (2) Binder Mixing Step S2

The binder mixing step S2 is a step of mixing a binder including one or more selected from polysaccharides and proteins with an aqueous solution including a surfactant. The foam material 1 used in the present technology can be produced by mixing all materials in the mixing step S3 described below without performing the binder mixing step S2. However, it is favorable to perform the binder mixing step S2. By performing the binder mixing step S2, it is possible to efficiently and sufficiently mix the binder and the surfactant in the aqueous solution.

### (3) Mixing Step S3

The mixing step S3 is a step of mixing various components used in the foam material 1 according to the present technology. Specifically, it is a step of mixing a fibrous material, a binder, a foam promotor, a surfactant, a water-soluble softener, and, as necessary, other components such as a discoloration inhibitor and an antibacterial agent.

Note that the mixing step S3 can also be performed simultaneously with the foaming step S4 described below. That is, foaming may be performed simultaneously while mixing the various components.

### (4) Foaming Step S4

The foaming step S4 is a step of foaming the mixture of the various components used in the foam material 1 according to the present technology. Specifically, it is a step of foaming a mixture of a fibrous material, a binder, a foam promotor, a surfactant, a water-soluble softener, and, as necessary, other components such as a discoloration inhibitor and an antibacterial agent.

As the foaming method in the foaming step S4, one or two or more types of general foaming methods can be combined and used as long as the effects of the present technology are not impaired. Examples thereof include a method of foaming the mixture while stirring and mixing, a method of foaming by forcing gas into the mixture, and a method of foaming the mixture by adding a foaming agent or the like.

Specifically, for example, the mixing step S3, a composition including the various components used in the foam material 1 used in the present technology can be mixed at a first rotational speed. More specifically, in the mixing step S3, a composition including a fibrous material, a binder, sodium hydrogen carbonate, a surfactant, a water-soluble softener, and, as necessary, other components such as a discoloration inhibitor and an antibacterial agent can be mixed at the first rotational speed.

Note that the mixing step S3 also includes a case where foaming occurs simultaneously while mixing the composition including the various components. That is, foaming is started while mixing the composition at the first rotational speed in the mixing step S3, and further foaming can be performed while mixing the composition at a second rotational speed in the foaming step S4.

In the foaming step S4, the composition including the various components used in the present technology can be foamed at the second rotational speed faster than the first rotational speed. More specifically, the foaming step S4 is a step of forming a composition including a fibrous material, a binder, sodium hydrogen carbonate, a surfactant, a water-soluble softener, and, as necessary, other components such as a discoloration inhibitor and an antibacterial agent at the second rotational speed faster than the first rotational speed.

In order to reduce the specific gravity of the foam material using a fibrous material that includes waste paper and/or pulp for the purpose of improving the cushioning properties or the like thereof, it has been necessary to take measures, e.g., the materials used in the foam material are added separately when mixing the materials or mixing is performed in a stepwise manner by changing the rotational speed for mixing, which complicates the production step. Meanwhile, the present inventors have successfully produced, by using sodium hydrogen carbonate (baking soda) as a foam promotor, a foam material having excellent cushioning properties and small specific gravity by mixing each material at once and in one stage without changing the rotational speed.

### (5) Molding Step S5

The molding step S5 is a step of molding the composition (foamed mixture) into a desired shape. As the molding method in the molding step S5, one or two or more types of general molding methods can be combined and used as long as the effects of the present technology are not impaired. Examples thereof include injection molding, extrusion molding, press molding, blow molding, calendar molding, and casting molding.

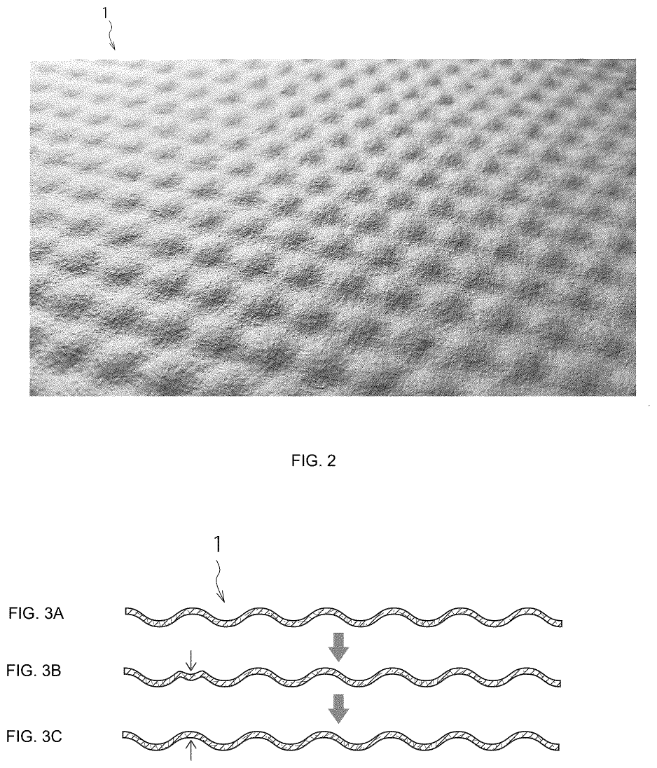

The specific shape molded in the molding step S5 is not particularly limited and can be freely designed in accordance with the uses of the foam material 1 to be produced, and the like. For example, it can be formed into an embossed sheet shape as shown in FIG. 2 and FIG. 3. By embossing, for example, even if a recess has been partially formed (see Part B of FIG. 3) as shown in FIG. 3, it will be restored by its resilience (see Part C of FIG. 3) and can be used suitably as a cushioning material and a package material.

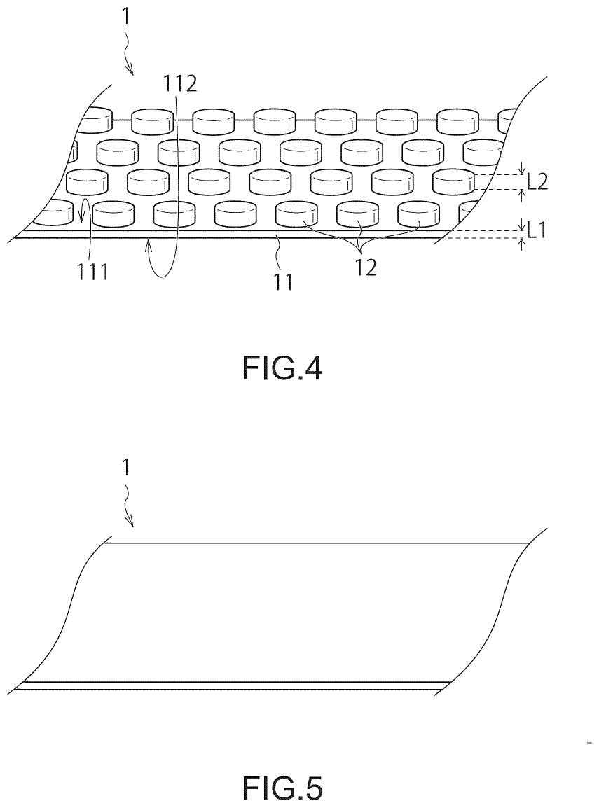

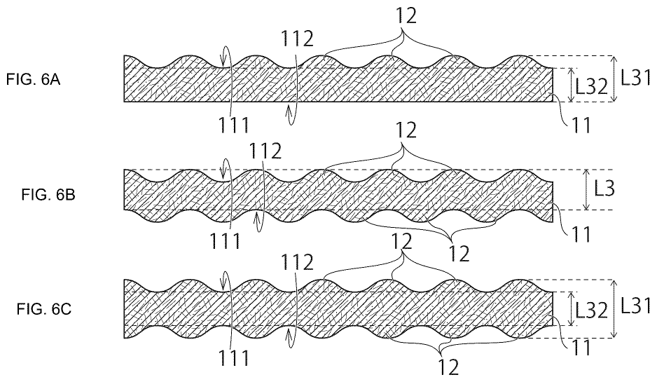

Further, for example, it can be molded into a shape that replaces an air cap as shown in FIG. 4, a simple sheet shape as shown in FIG. 5, or a shape having wavy projecting portions on one or both sides as shown in Parts A to C of FIG. 6.

The foam material 1 used as the package material according to the present technology can include a sheet-shaped base layer 11 having a first surface 111 and a second surface 112. A thickness L1 of the base layer 11 can be freely designed in accordance with the application and purpose of the foam material 1. The thickness L1 of the base layer 11 is, for example, 1 mm or more, favorably 2 mm or more, and can be 3 mm considering the cushioning properties and moldability. By setting the thickness L1 of the base layer 11 within this range, it is possible to further improve the strength of the foam material 1.

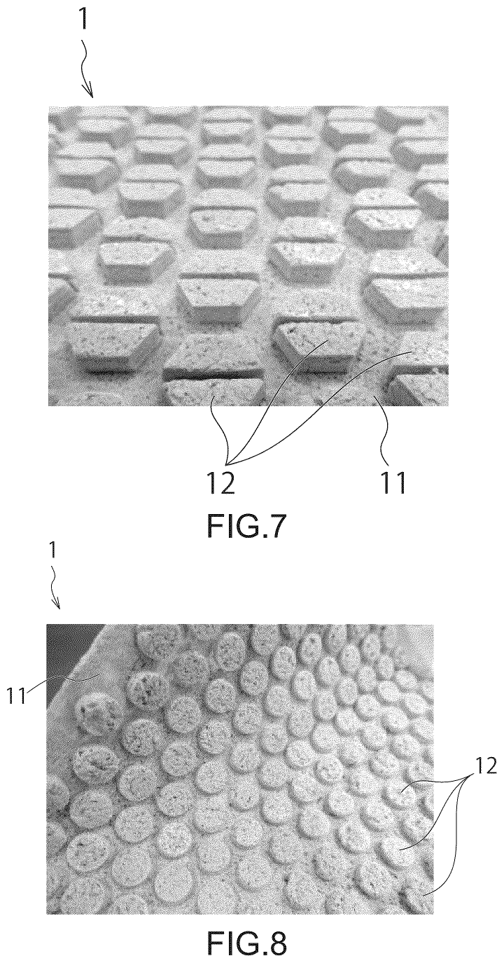

A plurality of structures 12 can be formed on the first surface 111 and/or the second surface 112 of the base layer 11. The shape of the structure 12 is not particularly limited, and the structure 12 can be formed into the shape shown in FIG. 4 and FIG. 6, the shape shown in FIG. 7 described below, or the like. Further, although not shown, the structures 12 of different shapes can be combined or the plurality of structures 12 can be formed in different shapes. Further, the plurality of structures 12 can be formed with intervals therebetween.

The thickness of the structure 12 can also be freely designed in accordance with the application and purpose of the foam material 1. A thickness L2 of the structure 12 can be, for example, 2 to 10 mm, favorably 8 to 10 mm in the case of, for example, the shape shown in FIG. 7 described below, and favorably 2 to 6 mm in the case of, for example, the shape shown in FIG. 8 described below. By setting the thickness L2 of the structure 12 within this range, it is possible to further improve the strength of the foam material 1.

In the foam material 1 used as the package material according to the present technology, the thickness L2 of the structure 12 is favorably larger than the thickness L1 of the base layer 11. By setting the thickness L2 of the structure larger than the thickness L1 of the base layer 11, it is possible to further improve impact resistance, resilience after impact, and the like.

A thickness L3 of the foam material 1, which is the sum of the thickness L1 of the base layer 11 and the thickness L2 of the structure 12, may be a constant thickness as shown in Part B of FIG. 6, or the foam material 1 may have a structure including a thick portion L31 and a thin portion L32 as shown in Part A or C of FIG. 6.

In the foam material 1 used as the package material according to the present technology, the surface roughness of one or more surfaces selected from the first surface 111 and the second surface 112 of the base layer 11 and the surface of the structure 12 can also be freely designed in accordance with the application and purpose of the foam material 1.

In the molding step S5, a mold and/or an embossed sheet can be used. Various materials can be used as the materials of the mold and/or the embossed sheet used in the present technology as long as the effects of the present technology are not impaired. As the material of the mold and/or the embossed sheet that can be used in the present technology, both an organic material and an inorganic material can be used. Examples thereof include a silicone resin, an acrylic resin, a metal, a glass material, and a ceramic material. In the present technology, it is favorable to use a mold and/or an embossed sheet containing silicon, e.g., a silicone resin from the viewpoint of being capable of performing a drying step while the composition is poured onto the mold and/or the embossed sheet. By using the mold and/or the embossed sheet containing silicon, the mold releasability and transferability are improved and it is possible to improve the surface properties of each surface of the foam material 1 after molding.

### (6) Drying Step S6

The drying step S6 is a step of drying the composition (foamed mixture) 10 after the foaming step S4, which has been molded in the molding step S5 as necessary. As the drying method in the drying step S6, one or two or more types of drying methods can be combined and used as long as the effects of the present technology are not impaired. Examples thereof include natural drying, heat drying, hot air drying, reduced pressure drying, freeze drying, dehumidification drying, microwave drying, and light drying (infrared carbon lamp heater drying, infrared ceramic heater drying, etc.).

Example of the foam material 1 produced by performing the above steps are shown in the photographs substituted for a drawing in FIG. 2, FIG. 7, and FIG. 8. The example shown in FIG. 2 is an example in which an embossed sheet containing silicon is used to mold and produce in the molding step S5. The example shown in FIG. 7 and FIG. 8 are each an example in which a mold containing silicon is used to mold and produce in the molding step S5.

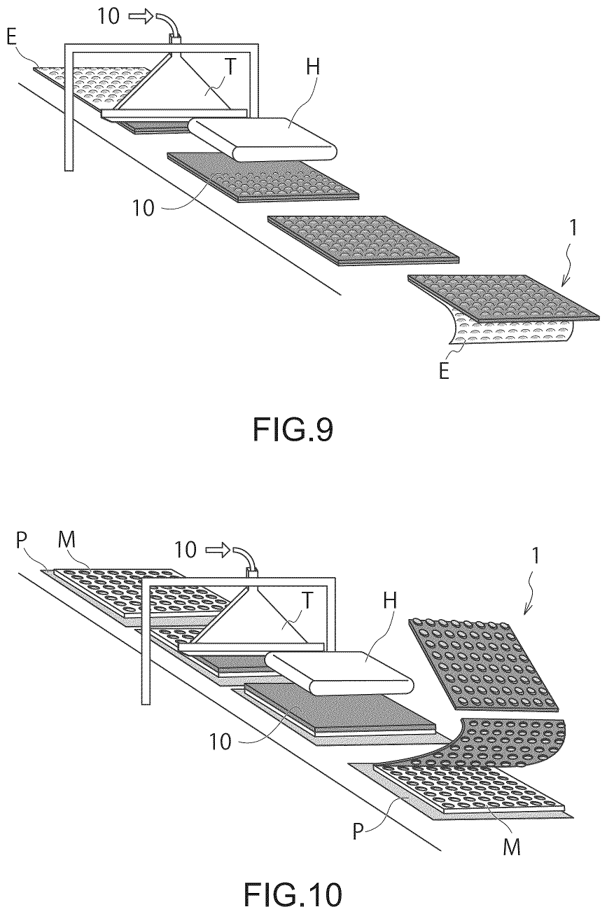

FIG. 9 is a schematic diagram showing an example of the method of producing the foam material 1 used in the present technology. The production method shown in FIG. 9 is an example of molding using a belt conveyor and an embossed sheet. The composition (foamed mixture) 10 that has been through the mixing step S3 and the foaming step S4 is poured into an embossed sheet E using an extruder T such as a T-die and is dried in this state using a dryer H such as a heater, and then, the embossed sheet E is peeled off from the foam material 1, thereby producing the foam material 1 used as the package material according to the present technology.

Note that although the composition (foamed mixture) 10 on the embossed sheet E is dried using the dryer H in the state following the shape of the embossed sheet E and the produced foam material 1 is also molded into an embossed sheet shape in the example shown in FIG. 9, the foam material 1 having the shape shown in Part A of FIG. 6 can be molded by increasing the thickness of the composition (foamed mixture) 10 to be poured onto the embossed sheet E. More specifically, by increasing the thickness of the composition (foamed mixture) 10 to be poured onto the embossed sheet E, the surface that is not in contact with the embossed sheet E in FIG. 9 becomes flat and forms the second surface 112 shown in Part A of FIG. 6, and the surface that is in contact with the embossed sheet E in FIG. 9 forms the first surface 111 shown in Part A of FIG. 6.

The specific thickness varies depending on the flow state of the composition (foamed mixture) 10, or the like. However, for example, when the thickness of the composition (foamed mixture) 10 to be poured onto the embossed sheet E is set to approximately 2 to 3 mm, the foam material 1 having the embossed sheet shape shown in FIG. 2 can be molded. When the thickness of the composition (foamed mixture) 10 to be poured onto the embossed sheet E is set to 5 mm or more, the foam material 1 having the shape as shown in Part A of FIG. 6 can be molded.

FIG. 10 is a schematic diagram showing an example of the method of producing the foam material 1 used in the present technology, which is different from that shown in FIG. 9. The production method shown in FIG. 10 is an example molding using a belt conveyor and a mold. The composition (foamed mixture) 10 that has been through the mixing step S3 and the foaming step S4 is poured into a mold M using the extruder T such as a T-die and is dried in this state using the dryer H such as a heater, and then, the foam material 1 is peeled off from the mold M, thereby producing the foam material 1 used as the package material according to the present technology.

At this time, from the viewpoint of improving moldability and improving the design and surface roughness of the produced foam material 1, the mold M favorably includes a hole for letting air out. Further, for example, it is favorable to lay a porous sheet P such as a sheet made of a mesh material under the mold M.

Note that although the drying step S6 is performed while the composition (foamed mixture) 10 has been poured into the mold M in the example shown in FIG. 10, the present technology is not limited thereto. Rough drying may be performed with the composition (foamed mixture) 10 poured into the mold M to the extent that the mold M can be peeled off, and main drying may be performed after being peeled off from the mold M.

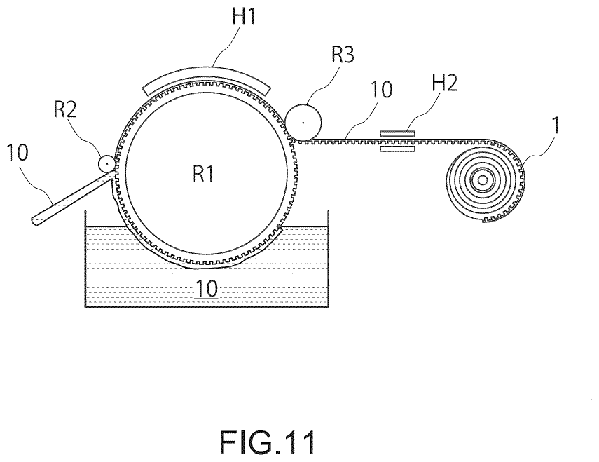

FIG. 11 is a schematic diagram showing an example of the method of producing the foam material 1 used in the present technology, which is different from those shown in FIG. 9 and FIG. 10. The production method shown in FIG. 11 is an example of molding using a roller R. A first roller R1 having recesses and projections on the surface thereof is partially immersed in a tank containing the composition (foamed mixture) 10 that has been through the mixing step S3 and the foaming step S4 to deposit the composition (foamed mixture) 10 on the surface of the first roller R1. At this time, the recesses and projections on the surface of the roller R1 may include holes through which the composition (foamed mixture) 10 does not flow, and the composition (foamed mixture) 10 may be deposited on the surface of the first roller R1 by suctioning from inside the roller R1.

The foam material 1 used as the package material according to the present technology can be produced by smoothing the surface of the composition (foamed mixture) 10 deposited on the surface of the first roller R1 using a second roller R2, a belt saw (not shown), or the like, performing rough drying using a first drier H1 such as a heater, then taking it up using a third roller R3 or the like, and performing main drying using the second drier H2 such as a heater.

Note that although rough drying is performed using the first dryer H1 on the first roller R1, and then, main drying is performed using the second dryer H2 after being peeled off from the first roller R1 in the example shown in FIG. 11, the present technology is not limited thereto. After completely drying using the first drier H1 on the first roller R1, the foam material 1 may be peeled off from the first roller R1. Further, by providing a heating mechanism to the first roller R1, drying can be performed using only the heat of the first roller R1 without using the drier H1.

### Second Embodiment

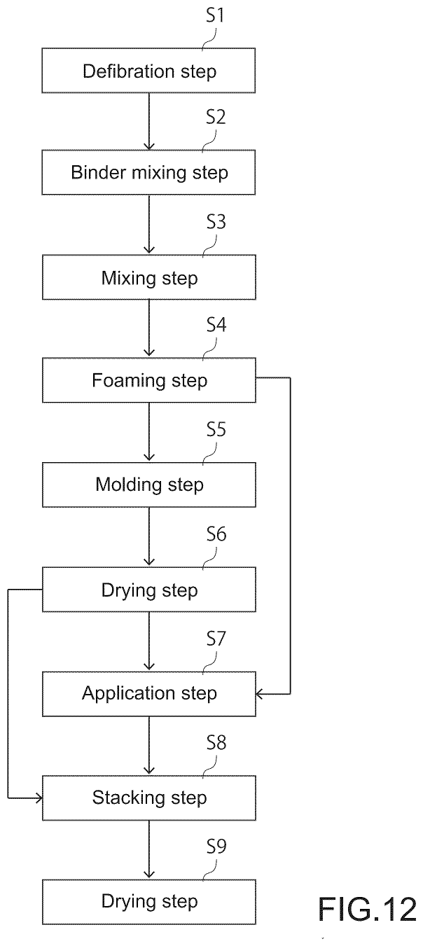

FIG. 12 is a flowchart of a second embodiment of the method of producing the foam material 1 used in the present technology. The method of producing the foam material 1 according to the second embodiment is a method of further performing the application step S7, the stacking step S8, and the drying step S9 in addition to the steps performed in the production method according to the first embodiment.

### (7) Application Step S7

The application step S7 is a step of applying the composition (foamed mixture) 10 after the foaming step S4 onto the surface of the foam material 1 produced by the production method according to the first embodiment. As the application method in the application step S7, one or two or more types of general application methods can be combined and used as long as the effects of the present technology are not impaired. Examples thereof include methods such as roll coating, kiss coating, spray coating, brush painting, and transfer using a stamp.

### (8) Stacking Step S8

The stacking step S8 is a step of stacking the foam material 1 produced by the production method according to the first embodiment on the surface on which the composition (foamed mixture) 10 has been applied in the application step S7. That is, in the stacking step S8, the foam material 1, the composition (foamed mixture) 10 before drying, and the foam material 1 are stacked in this order. At this time, the composition (foamed mixture) 10 before drying sandwiched between the foam materials 1 functions as an adhesive for adhering the foam materials 1 to each other.

### (9) Drying Step S9

The drying step S9 is a step of drying the stacked body after the stacking step S8. In the drying step S9, actually, since the foam material 1 has been already dried, the composition (foamed mixture) 10 sandwiched between the foam materials 1 is dried. Since the drying method in the drying step S9 is similar to that in the above-mentioned drying step S6, description thereof is omitted here.

As the thickness of the composition (foamed mixture) 10 increases, the drying time in the above-mentioned drying step S6 becomes longer. In this regard, by performing the drying step S9 while the foam materials 1 that has already been produced are adhered using the composition (foamed mixture) 10 before drying as in the production method according to the second embodiment, it is possible to efficiently produce the foam material 1 having a large thickness.

### 3. Composite Material 2

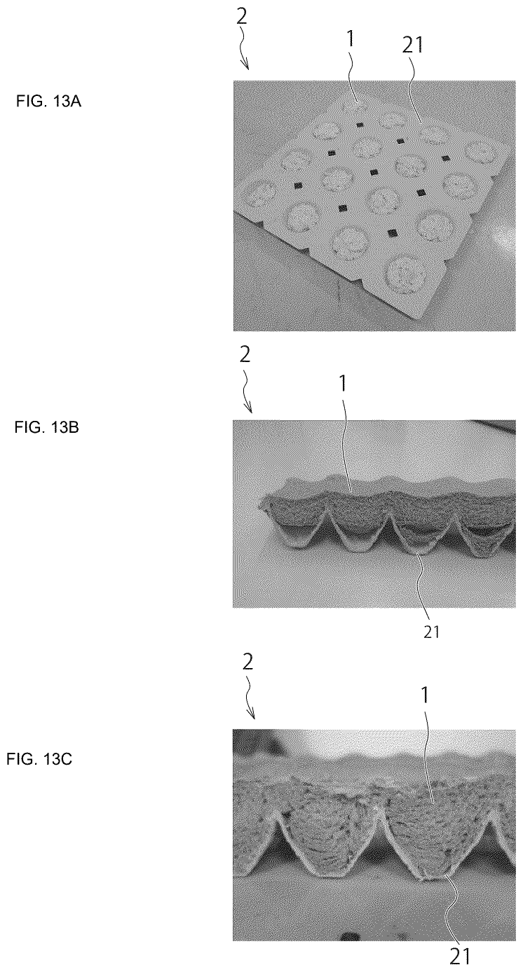

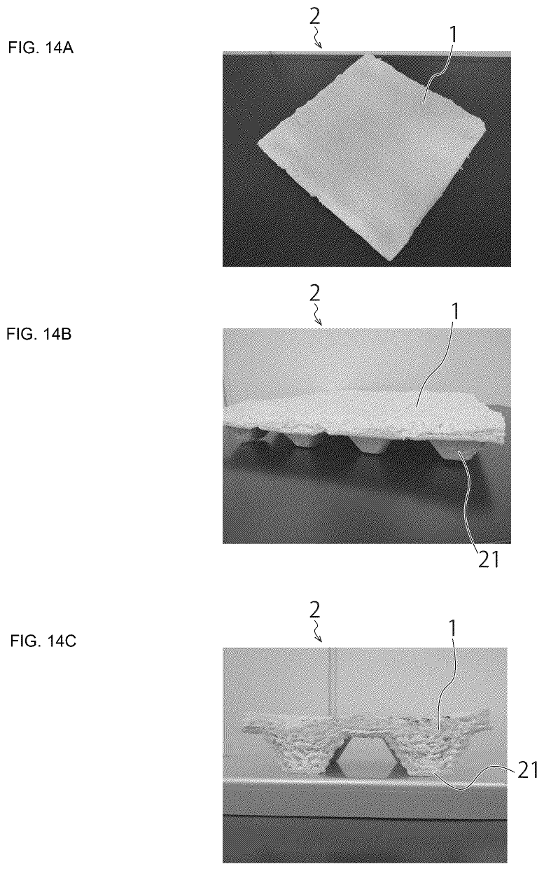

FIG. 13 and FIG. 14 are each a photograph substituted for a drawing showing an example of a composite material 2 that can be used as the package material according to the present technology. The composite material 2 used in the present technology includes the above-mentioned foam material 1 used in the present technology and a base material (member) 21.

### (1) Base Material (Member) 21

The base material (member) 21 of the composite material 2 used in the present technology is not particularly limited as long as the effects of the present technology are not impaired, and the base material (member) 21 using any material can be used. As the material of the base material (member) 21 that can be used in the present technology, waste paper such as newspaper, a magazine, a book, and cardboard; pulp such as bamboo, bagasse, and straw; fabric such as cotton fabric, wool fabric, and chemical fiber fabric; a resin, and the like can be used. In the present technology, it is favorable to use the base material (member) 21 including waste paper and/or pulp. By using a fibrous material that includes waste paper and/or pulp, it is possible to improve the recyclability. Examples of the waste paper include newspaper, a magazine, a book, and cardboard as described above. Examples of the pulp include wood and non-wood. Examples of the non-wood include bamboo, bagasse, and straw.

The examples shown in FIG. 13 and FIG. 14 are each an example of using a pulp mold as the base material (member) 21. The pulp mold is a recyclable base material (member) 21 using waste paper such as cardboard as a raw material, but has a problem that it has no resilience and low cushioning properties. However, by combining it with the foam material 1 used in the present technology, the composite material 2 to which resilience is imparted can be obtained and it is possible to improve cushioning properties.

The method of bonding the foam material 1 and the base material 21 is not particularly limited as long as the effects of the present technology are not impaired. For example, they can be bonded via an adhesive layer or they can be bonded by bonding the composition (foamed mixture) 10 before drying to the base material 21 and then drying it. Note that since the adhesive layer is the same as an adhesive layer 32 of a multilayer structure 3 described below, description thereof is omitted here.

### (2) Uses of Composite Material 2

The uses of the composite material 2 used in the present technology are not particularly limited. However, the foam material 1 can be suitably used for applications such as a cushioning material, a package material, a sound absorbing material, a sound insulation material, a soundproofing material, a vibration isolating material, an insulation material, wallpaper, a seat for automobiles, a curing material, and an agricultural material.

Further, by using a recyclable material as the base material (member) 21, it can be expected to be used as a recycled material.

### 4. Method of Producing Composite Material 2

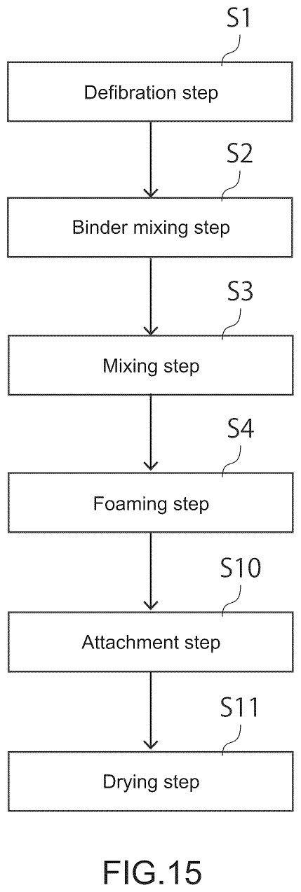

FIG. 15 is a flowchart of a first embodiment of a method of producing the composite material 2 used in the present technology. The method of producing the composite material 2 used in the present technology is a method of performing at least the foaming step S4, an attachment step S10, and a drying step S11. Further, as necessary, the defibration step S1, the binder mixing step S2, the mixing step S3, and the like may be performed. Details of each step will be described below. Note that since the defibration step S1, the binder mixing step S2, the mixing step S3, and the foaming step S4 are respectively the same as the defibration step S1, the binder mixing step S2, the mixing step S3, and the foaming step S4 in the above-mentioned method of producing the foam material 1 used in the present technology, description thereof is omitted here.

### (1) Attachment Step S10

The attachment step S10 is a step of attaching the composition (foamed mixture) 10 before the foaming step S4 to the base material (member) 21 before the drying step S11 described below. In the attachment step S10, the specific method is not particularly limited as long as the composition (foamed mixture) 10 before drying can be brought into contact with another base material (member) 21. Examples thereof include a method of attaching by stacking the composition (foamed mixture) 10 before drying to the base material (member) 21, a method of attaching by applying the composition (foamed mixture) 10 before drying to the base material (member) 21, and a method of attaching by filling a predetermined portion of the base material 21 with the composition (foamed mixture) 10 before drying.

### (2) Drying Step S11

The drying step S11 is a step of drying the composition (foamed mixture) 10 after the attachment step S10. By drying the composition (foamed mixture) 10 before drying while it is attached to another base material (member) 21, the foam material 1 is formed while being bonded to the base material (member) 21. That is, the composite material 2 including the foam material 1 and the base material (member) 21 can be produced. Since the drying method in the drying step S11 is similar to that in the above-mentioned drying step S6, description thereof is omitted here.

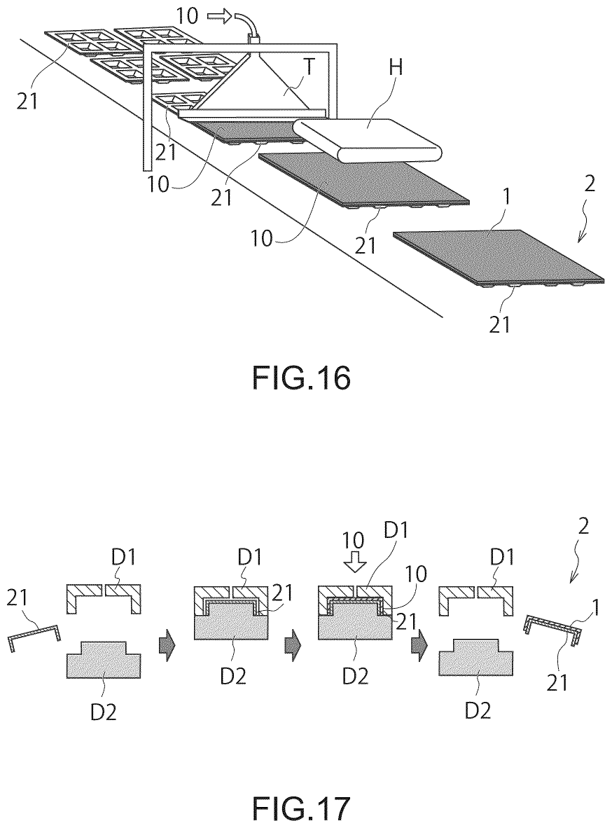

FIG. 16 is a schematic diagram showing an example of the method of producing the composite material 2 used as the package material according to the present technology. The production method shown in FIG. 16 is an example of molding using a belt conveyor. The composition (foamed mixture) 10 that has been through the mixing step S3 and the foaming step S4 is poured into the base material (member) 21 using the extruder T such as a T-die and is dried in this state using the dryer H such as a heater, thereby producing the composite material 2 used as the package material according to the present technology.

At this time, for example, by using the base material (member) 21 made of a material having air permeability, such as a pulp mold, as the base material (member) 21, it is possible to improve moldability and improve the design and surface roughness of the produced foam material 1 because when the composition (foamed mixture) 10 is poured into the base material (member) 21, air can be let out from the base material (member) 21.

FIG. 17 is a schematic diagram showing an example of the method of producing the composite material 2 used as the package material according to the present technology, which is different from that shown in FIG. 16. The production method shown in FIG. 17 is an example of performing injection molding using a mold. For example, the composition (foamed mixture) 10 that has been through the mixing step S3 and the foaming step S4 is injected and dried while the base material (member) 21 is set in a fixed-side mold D1 using a movable-side mold, thereby producing the composite material 2 used as the package material according to the present technology.

### 5. Multilayer Structure 3

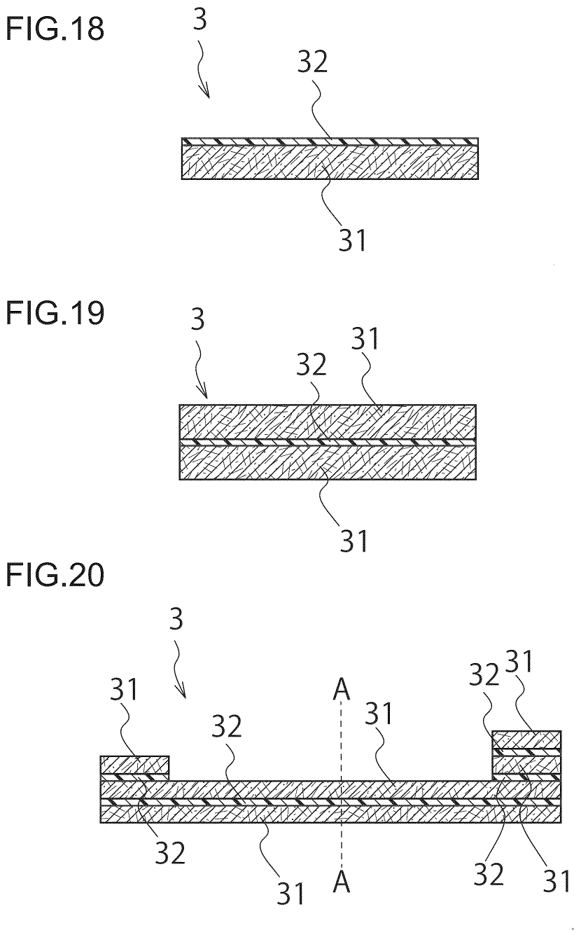

FIG. 18 is a schematic diagram showing a first embodiment of the multilayer structure 3 that can be used as the package material according to the present technology. The multilayer structure 3 used in the present technology includes a foam material layer 31 including the above-mentioned foam material 1 used in the present technology, and an adhesive layer 32.

### (1) Adhesive Layer 32

The material forming the adhesive layer 32 is not particularly limited as long as the foam materials 1 can be bonded to each other or the foam material 1 and another base material (member) 21 can be bonded to each other, and various materials having adhesive properties can be used. For example, an adhesive made of a resin can be used. Examples of the resin forming an adhesive include a urethane resin, a polyolefin resin, an acrylic resin, and an epoxy resin, and these resins can be used alone or used in combination. Further, as in the above-mentioned method of producing the foam material 1 according to the second embodiment, the foamed mixture before drying may be used as an adhesive layer.

### (2) Form of Multilayer Structure 3

The multilayer structure 3 used in the present technology only needs to include at least one or more foam material layers 31 and one or more adhesive layers 32, and the number of each layer is not particularly limited. As in the multilayer structure 3 according to the first embodiment shown in FIG. 18, a structure that includes one foam material layer 31 and one adhesive layer 32, in which, for example, the foam material layer 31 and another base material (member) 21 (not shown) are bonded to each other via the adhesive layer 32, may be provided.

Further, for example, as in the multilayer structure 3 according to a second embodiment shown in FIG. 19, a structure in which the foam material layers 31 are bonded to each other via the adhesive layer 32 may be provided.

Further, the foam material layer 31 and the adhesive layer 32 may each include two or more layers. For example, as in the multilayer structure 3 according to a third embodiment shown in FIG. 20, a structure in which layers whose numbers differ in accordance with the uses of the multilayer structure 3, and the like are freely combined may be provided.

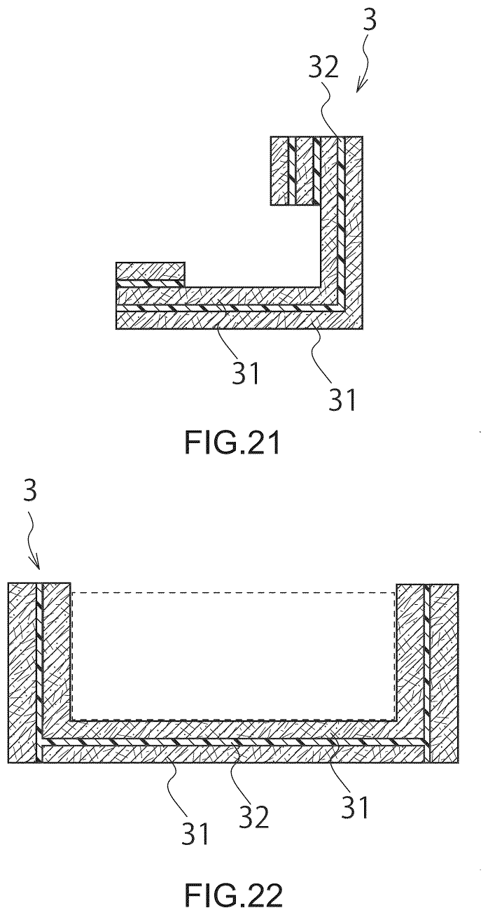

Further, for example, the multilayer structure 3 according to the third embodiment shown in FIG. 20 can be folded along the line A-A in FIG. 20 to form the multilayer structure 3 according to a fourth embodiment shown in FIG. 21.

In addition, as in the multilayer structure 3 according to a fifth embodiment shown in FIG. 22, for example, in the case of using the multilayer structure 3 as a package material, a stacked structure may be formed in accordance with the shape of a product to be packaged (shown by a broken line in the figure).

### (3) Uses of Multilayer Structure 3

The uses of the multilayer structure 3 used in the present technology described above are not particularly limited. However, the foam material 1 can be suitably used for applications such as a cushioning material, a package material, a sound absorbing material, a sound insulation material, a soundproofing material, a vibration isolating material, an insulation material, wallpaper, a seat for automobiles, a curing material, and an agricultural material.

Further, by using a recyclable material as the above-mentioned adhesive layer 32, it can be expected to be used as a recycled material.

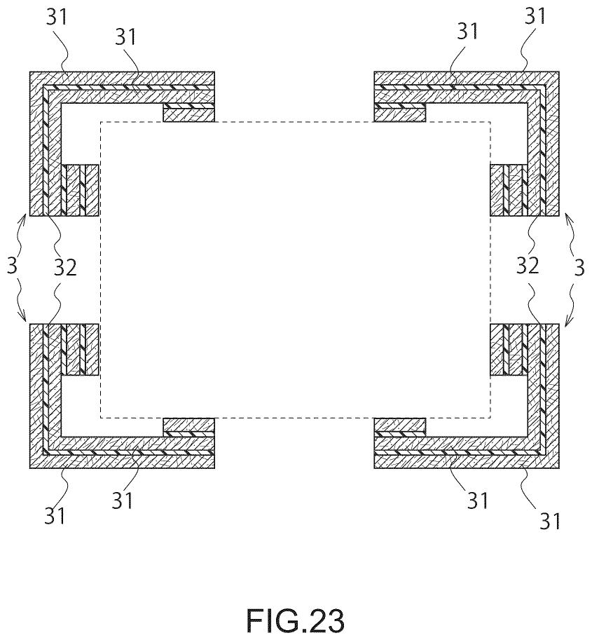

The multilayer structure 3 used in the present technology can be used for various applications in a state in which a plurality of multilayer structures 3 is combined. As in the multilayer structure 3 according to a sixth embodiment shown in FIG. 23, for example, in the case of using the multilayer structure 3 as a package material, a product to be packaged (shown by a broken line in the figure) can be packaged using a plurality of multilayer structures 3.

### 6. Method of Producing Multilayer Structure 3

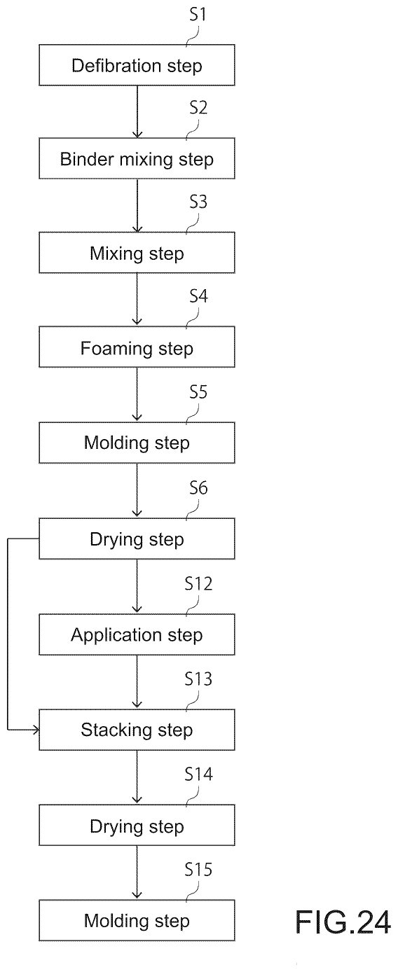

FIG. 24 is a flowchart of a first embodiment of a method of producing the multilayer structure 3 used in the present technology. The method of producing the multilayer structure 3 used in the present technology is a method of performing at least the foaming step S4, the drying step S6, and a stacking step S13. Further, as necessary, the defibration step S1, the binder mixing step S2, the mixing step S3, the molding step S5, an application step S12, a drying step S14, a molding step S15, and the like may be performed. Details of each step will be described below. Note that since the defibration step S1, the mixing step S3, the foaming step S4, and the molding step S5 are respectively the same as the defibration step S1, the binder mixing step S2, the mixing step S3, the foaming step S4, and the molding step S5 in the above-mentioned method of producing the foam material 1 used in the present technology, description thereof is omitted here.

### (1) Application Step S12

The application step S12 is a step of applying an adhesive onto the surface of the foam material 1 produced through the drying step S6. Since the application method in the application step S12 is similar to that in the above-mentioned application step S7, description thereof is omitted here.

### (2) Stacking Step S13

The stacking step S13 is a step of stacking the foam materials 1 after the drying step via an adhesive layer. That is, in the stacking step S13, the foam material 1, an adhesive, and the foam material 1 are stacked in this order.

### (3) Drying Step S14

The drying step S14 is a step of drying the adhesive after the stacking step S13 to form the adhesive layer 32. Since the drying method in the drying step S14 is similar to that in the above-mentioned drying step S6, description thereof is omitted here.

### (4) Molding Step S15

The molding step S15 is a step of molding the produced multilayer structure 3 into a desired shape. For example, as described above, the multilayer structure 3 according to the third embodiment shown in FIG. 20 can be folded along the line A-A in FIG. 20 to form the multilayer structure 3 according to the fourth embodiment shown in FIG. 21. The molding method performed in the molding step S15 is not limited to the method of molding by folding. Examples thereof include molding by cutting, molding by adhesion, molding by stacking, and molding by combining them.

### EXAMPLES

The present technology will be described below in more detail on the basis of Examples. Note that the Examples described below show an example of a typical Example of the present invention, and the present technology should not be interpreted narrowly thereby.

### Experimental Example 1

In Experimental Example 1, the effect of differences in materials used in the foam material on the specific gravity was investigated. Note that in this Experimental Example, carboxymethyl cellulose was used as an example of polysaccharides.

### (1) Production of Foam Material

The materials shown in the following Table 1 and Table 2 were weighed out and prepared. A surfactant was added to 60° C. water and mixed, and then, a binder was added to the aqueous solution including the surfactant and mixed to prepare a binder+surfactant aqueous solution. The prepared binder+surfactant aqueous solution and other materials were mixed, and then further stirred and mixed using a whisk to prepare the composition (foamed mixture) 10. The composition (foamed mixture) 10 was rolled out into a plate shape and naturally dried for 20 hours under conditions of a temperature of 23° C. and a humidity of 50% to produce the foam materials 1 as samples 1 and 2.

Note that all materials shown in the following Table 1 and Table 2 were mixed to produce a foam material as a control in the same manner as that for the samples 1 and 2.

TABLE 1

| | | |
|---|---|---|
| Paper material | Type | Cardboard waste paper (pre-shredded) |
| | Amount | 100 |
| | added(g) | |
| Binder | Type | See Table 2 |
| | Amount | |
| | added(g) | |
| Surfactant | Type | Polyoxyethylene alkylether* |
| | Amount | See Table 2 |
| | added(g) | |
| Discoloration | Type | Alum |
| inhibitor | Amount | 1.75 (Water: 35) |
| | added(g) | |
| Antifungal agent/ | Type | Potassium sorbate |
| antibacterial agent | Amount | 0.34 |
| | added(g) | |
| Foam promotor | Type | Sodium hydrogen carbonate (baking soda) |
| | Amount | 5 |
| | added(g) | |
| Softener | Type | Glycerin |
| | Amount | 45 |
| | added(g) | |

*“HITENOL (registered trademark)”, DKS Co. Ltd.

### (2) Measurement of Specific Gravity

The specific gravity of each of the binder+surfactant aqueous solution, the foamed mixture, and a foam product was measured in accordance with JIS Z8804.

### (3) Results

Results are shown in table 2.

TABLE 2

| | | | Sample | |
|---|---|---|---|---|
| | | Control | 1 | 2 |
| Binder | Type | Polyvinyl- | Polysac- | Polysac- |
| | | alcohol | charide | charide |
| | | | 1 ^{*1} | 2 ^{*2} |
| | Amount added | 34 | 12.75 | 12.75 |
| | (g) | (Water: 425) | | |
| | Concentration in | 7 | 3 | 3 |
| | binder aqueous | | | |
| | solution (mass %) | | | |
| Surfactant | Amount added | 0.9 | 21.9 | 21.9 |
| | (g) | (Water: 100) | | |
| | Concentration in | — | 5 | 5 |
| | binder + | | | |
| | surfactant aqueous | | | |
| | solution (mass %) | | | |
| Water (g) | | 525 | 425 | 425 |
| Specific | Binder + surfactant | — | 0.285 | 0.266 |
| gravity | aqueous solution | | | |
| | Foamed mixture | 0.36~0.37 | 0.33 | 0.244 |

^{*1} “SUNROSE (registered trademark) F01”, NIPPON PAPER INDUSTRIES CO., LTD.
^{*2} “Blanose (registered trademark) 7L1C1”, Sumitomo Pharma Food & Chemical Co., Ltd.

As shown in Table 2, despite that the foam materials 1 as the samples 1 and 2 used polysaccharides as a binder, they had specific gravity equivalent to that of the control using a binder derived from petroleum. From these results, it was found that by using a binder including polysaccharides, proteins, or the like, a foam product that has high contribution to the environment while having the quality equivalent to that of the existing foam product using a binder derived from petroleum can be obtained.

### Experimental Example 2

In Experimental Example 2, the effect of differences in the concentration of the binder and the surfactant on the foaming property was investigated. In this Experimental Example, carboxymethyl cellulose (“SUNROSE (registered trademark) F01”, NIPPON PAPER INDUSTRIES CO., LTD.), which is one of polysaccharides, was used as an example of the binder, and polyoxyethylene alkylether (“HITENOL (registered trademark)”, DKS Co. Ltd.) was used as an example of the surfactant.

$$Preparation of binder + surfactant aqueous solution \qquad ( 1 )$$

The materials shown in the following Table 3 were weighed out, a surfactant was added to 60° C. water and mixed, and then, a binder was added to the aqueous solution including the surfactant and mixed to prepare the binder+surfactant aqueous solution.

$$\begin{matrix}Evaluation & \\ [ Specific gravity ] \\ The specific gravity of the prepared binder + surfactant aqueous solution was measured in accordance with JIS Z8804 . & ( 2 )\end{matrix}$$

### [Foaming Property]

The height of the bubbles in the prepared binder+surfactant aqueous solution was observed and the foaming property was evaluated by ranking them from 1 to 7 from the highest.

### (3) Results

The results are shown in Table 3.

TABLE 3

| | | | Binder | | Surfactant | | Evaluation | |
|---|---|---|---|---|---|---|---|---|
| | | Water | | Mass | | Mass | Specific | Foaming |
| | | cc | g | %^{*1} | g | %^{*2} | gravity | property |
| Binder + | 1 | 500 | 25 | 5 | 2.50 | 1 | 0.681 | 6 |
| surfactant | 2 | 500 | 15 | 3 | 0.15 | 0.1 | 0.734 | 7 |
| aqueous | 3 | 500 | 15 | 3 | 5.15 | 1 | 0.58 | 5 |
| solution | 4 | 500 | 15 | 3 | 10.30 | 2 | 0.514 | 4 |
| | 5 | 500 | 15 | 3 | 15.45 | 3 | 0.441 | 3 |
| | 6 | 500 | 15 | 3 | 20.60 | 4 | 0.427 | 2 |
| | 7 | 500 | 15 | 3 | 24.75 | 5 | 0.293 | 1 |

^{*1} Concentration in binder aqueous solution
^{*2} Concentration in binder + surfactant aqueous solution

It was found from the results of the aqueous solutions 2 to 7 in Table 3 that the foaming property is improved and the specific gravity decreases as the amount of the surfactant increases. Further, comparing the aqueous solutions 1 and 3 in Table 3, it was found that the foaming property decreases and the specific gravity increases as the amount of the binder increases.

Note that the present technology may also take the following configurations.

(1)

A package material, including:
a fibrous material that includes waste paper and/or pulp;
a binder;
sodium hydrogen carbonate;
a surfactant; and
a water-soluble softener,
the binder including one or more selected from polysaccharides and proteins,
the softener being a urea derivative having a chemical structural formula of R¹, R²—N—CO—N—R³, R⁴ (R¹ to R⁴: H or a saturated and/or unsaturated hydrocarbon group having 1 to 4 carbon atoms).
   (2)

A package material, including:
a fibrous material that includes waste paper and/or pulp;
a binder;
sodium hydrogen carbonate;
a surfactant; and
a water-soluble softener,
the binder including one or more selected from polysaccharides and proteins,
the softener being a water-soluble polyhydric alcohol having 3 to 15 carbon atoms,
the number of carbon atoms and the number of hydroxy (OH) groups in a molecular structure of the polyhydric alcohol satisfying the following relationship: the number of hydroxy groups<the number of carbon atoms.
   (3)

The package material according to (1) or (2), further including
a discoloration inhibitor.
   (4)

The package material according to (3), wherein
the discoloration inhibitor includes alum.
   (5)

The package material according to any one of (1) to (4), further including
an antibacterial agent.
   (6)

The package material according to (5), wherein
the antibacterial agent includes potassium sorbate.
   (7)

The package material according to any one of (1) to (6), wherein
the surfactant includes polyoxyethylene alkylether.
   (8)

The package material according to any one of (1) to (7), which has an embossed sheet shape.

(9)

The package material according to any one of (1) to (8), further including
a base layer having a thickness of 1 mm or more, the base layer having a sheet shape having a first surface and a second surface.
   (10)

The package material according to (9), further including
a structure layer in which a plurality of structures is formed on the first surface and/or the second surface of the base layer.
   (11)

The package material according to (10), wherein
the structure layer has a thickness larger than a thickness of the base layer.
   (12)

The package material according to (10) or (11), wherein
the plurality of structures is formed with intervals therebetween.
   (13)

The package material according to any one of (8) to (12), wherein
the package material is bonded to the base material via an adhesive layer.
   (14)

A method of producing a package material, including:
a binder mixing step of mixing a binder including one or more selected from polysaccharides and proteins with an aqueous solution including a surfactant;
a mixing step of mixing a composition that includes an aqueous solution including the surfactant and the binder, a fibrous material that includes waste paper and/or pulp, sodium hydrogen carbonate, and a softener that is a urea derivative having a chemical structural formula of R¹, R²—N—CO—N—R³, R⁴ (R¹ to R⁴: H or a saturated and/or unsaturated hydrocarbon group having 1 to 4 carbon atoms); and
a foaming step of foaming the composition.
   (15)

The method of producing a package material according to (14), further including
a molding step of molding the composition using a mold and/or an embossed sheet.
   (16)

The method of producing a package material according to (14) or (15), further including
a drying step of drying the foamed composition.
   (17)

The method of producing a package material according to (15) or (16), wherein
the mold and/or the embossed sheet includes silicon.
   (18)

A foam material, including:
a fibrous material that includes waste paper and/or pulp;
a binder;
sodium hydrogen carbonate;
a surfactant; and
a water-soluble softener,
the binder including one or more selected from polysaccharides and proteins,
the softener being a urea derivative having a chemical structural formula of R¹, R²—N—CO—N—R³, R⁴ (R¹ to R⁴: H or a saturated and/or unsaturated hydrocarbon group having 1 to 4 carbon atoms).
   (19)

A foam material, including:
a fibrous material that includes waste paper and/or pulp;
a binder;
sodium hydrogen carbonate;
a surfactant; and
a water-soluble softener,
the binder including one or more selected from polysaccharides and proteins,
the softener being a water-soluble polyhydric alcohol having 3 to 15 carbon atoms,
the number of carbon atoms and the number of hydroxy (OH) groups in a molecular structure of the polyhydric alcohol satisfying the following relationship: the number of hydroxy groups<the number of carbon atoms.
   (20)

The foam material according to (18) or (19), further including
a discoloration inhibitor.
   (21)

The foam material according to (20), wherein
the discoloration inhibitor includes alum.
   (22)

The foam material according to any one of (18) to (21), further including
an antibacterial agent.
   (23)

The foam material according to (22), wherein
the antibacterial agent includes potassium sorbate.
   (24)

The foam material according to any one of (18) to (23), wherein
the surfactant includes polyoxyethylene alkylether.
   (25)

A composite material, including:
the foam material according to any one of (18) to (24); and
a member.
   (26)

A multilayer structure, including:
a foam material layer made of the foam material according to any one of (18) to (24); and
an adhesive layer.
   (27)

A cushioning material, including:
the foam material according to any one of (18) to (24).
   (28)

A composite cushioning material, including:
the foam material according to any one of (18) to (24);
a cushioning material.
   (29)

A recycled material, including:
the foam material according to any one of (18) to (24).
   (30)

A composite recycled material, including:
the foam material according to any one of (18) to (24); and
a recycled material.
   (31)

A method of producing a foam material, including:
a binder mixing step of mixing a binder including one or more selected from polysaccharides and proteins with an aqueous solution including a surfactant;
a mixing step of mixing a composition that includes an aqueous solution including the surfactant and the binder, a fibrous material that includes waste paper and/or pulp, sodium hydrogen carbonate, and a softener that is a urea derivative having a chemical structural formula of R¹, R²—N—CO—N—R³, R⁴ (R¹ to R⁴: H or a saturated and/or unsaturated hydrocarbon group having 1 to 4 carbon atoms); and
a foaming step of foaming the composition.
   (32)

The method of producing a foam material according to (31), further including
a molding step of molding the composition using a mold and/or an embossed sheet.
   (33)

The method of producing a foam material according to (31) or (32), further including
a drying step of drying the foamed composition.
   (34)

The method of producing a foam material according to (32) or (33), wherein
the mold and/or the embossed sheet includes silicon.
   (35)

A method of producing a composite material, including:
a binder mixing step of mixing a binder including one or more selected from polysaccharides and proteins with an aqueous solution including a surfactant;
a mixing step of mixing a composition that includes an aqueous solution including the surfactant and the binder, a fibrous material that includes waste paper and/or pulp, sodium hydrogen carbonate, and a softener that is a urea derivative having a chemical structural formula of R¹, R²—N—CO—N—R³, R⁴ (R¹ to R⁴: H or a saturated and/or unsaturated hydrocarbon group having 1 to 4 carbon atoms);
a foaming step of foaming the composition;
an attachment step of attaching a foamed mixture obtained by the foaming step to a member; and
a drying step of drying the foamed mixture after the attachment step.
   (36)

A method of producing a multilayer structure, including:
a binder mixing step of mixing a binder including one or more selected from polysaccharides and proteins with an aqueous solution including a surfactant;
a mixing step of mixing a composition that includes an aqueous solution including the surfactant and the binder, a fibrous material that includes waste paper and/or pulp, sodium hydrogen carbonate, and a softener that is a urea derivative having a chemical structural formula of R¹, R²—N—CO—N—R³, R⁴ (R¹ to R⁴: H or a saturated and/or unsaturated hydrocarbon group having 1 to 4 carbon atoms);
a foaming step of foaming the composition;
a drying step of drying a foamed mixture obtained by the foaming step; and
a stacking step of stacking a foam material obtained by the drying step via an adhesive layer.

### REFERENCE SIGNS LIST

foam material (package material): 1
base layer: 11
first surface of base layer 11: 111
second surface of the base layer 11: 112
structure: 12
composition: 10
defibration step: S1
binder mixing step: S2
mixing step: S3
foaming step: S4
molding step: S5, S15
drying step: S6, S9, S11, S14
embossed sheet: E
mold: M
porous sheet: P
extruder: T
dryer: H
application step: S7, S12
stacking step: S8, S13
composite material (package material): 2
base material (member): 21
attachment step: S10
multilayer structure (package material): 3
foam material layer: 31
adhesive layer: 32

1. A package material, comprising:
a fibrous material that includes waste paper and/or pulp;
a binder;
sodium hydrogen carbonate;
a surfactant; and
a water-soluble softener,
the binder including one or more selected from polysaccharides and proteins,
the softener being a urea derivative having a chemical structural formula of R¹, R²—N—CO—N—R³, R⁴ (R¹ to R⁴: H or a saturated and/or unsaturated hydrocarbon group having 1 to 4 carbon atoms).

2. A package material, comprising:
a fibrous material that includes waste paper and/or pulp;
a binder;
sodium hydrogen carbonate;
a surfactant; and
a water-soluble softener,
the binder including one or more selected from polysaccharides and proteins,
the softener being a water-soluble polyhydric alcohol having 3 to 15 carbon atoms,
the number of carbon atoms and the number of hydroxy (OH) groups in a molecular structure of the polyhydric alcohol satisfying the following relationship: the number of hydroxy groups<the number of carbon atoms.

3. The package material according to claim 1 or 2, further comprising
a discoloration inhibitor.

4. The package material according to claim 3, wherein
the discoloration inhibitor includes alum.

5. The package material according to claim 1 or 2, further comprising
an antibacterial agent.

6. The package material according to claim 5, wherein
the antibacterial agent includes potassium sorbate.

7. The package material according to claim 1 or 2, wherein
the surfactant includes polyoxyethylene alkylether.

8. The package material according to claim 1 or 2, which has an embossed sheet shape.

9. The package material according to claim 1 or 2, further comprising
a base layer having a thickness of 1 mm or more, the base layer having a sheet shape having a first surface and a second surface.

10. The package material according to claim 9, further comprising
a structure layer in which a plurality of structures is formed on the first surface and/or the second surface of the base layer.

11. The package material according to claim 10, wherein
the structure layer has a thickness larger than a thickness of the base layer.

12. The package material according to claim 11, wherein
the plurality of structures is formed with intervals therebetween.

13. The package material according to claim 9, wherein
the package material is bonded to the base material via an adhesive layer.

14. A method of producing a package material, comprising:
a binder mixing step of mixing a binder including one or more selected from polysaccharides and proteins with an aqueous solution including a surfactant;
a mixing step of mixing a composition that includes an aqueous solution including the surfactant and the binder, a fibrous material that includes waste paper and/or pulp, sodium hydrogen carbonate, and a softener that is a urea derivative having a chemical structural formula of R¹, R²—N—CO—N—R³, R⁴ (R¹ to R⁴: H or a saturated and/or unsaturated hydrocarbon group having 1 to 4 carbon atoms); and
a foaming step of foaming the composition.

15. The method of producing a package material according to claim 14, further comprising
a molding step of molding the composition using a mold and/or an embossed sheet.

16. The method of producing a package material according to claim 14 or 15, further comprising
a drying step of drying the foamed composition.

17. The method of producing a package material according to claim 15, wherein
the mold and/or the embossed sheet includes silicon.
